(19) United States
(12) Patent Application Publication
(10) Pub. No.: US 2012/0169131 A1
(43) Pub. Date: Jul. 5, 2012

(54) PHASE SHIFT POWER TRANSFER

(76) Inventors: Vijay N. Choudhary, Chandler, AZ (US); Robert Loke, Sunnyvale, CA (US)

(21) Appl. No.: 13/087,851

(22) Filed: Apr. 15, 2011

Related U.S. Application Data
(60) Provisional application No. 61/428,143, filed on Dec. 29, 2010.

(51) Int. Cl. H01F 38/14

(52) U.S. Cl. 307/104

(57) ABSTRACT

In a wireless energy transfer system, an apparatus includes a coil and an adjustable alternating current power supply electrically connected to the coil. When a device is in the vicinity of the apparatus, the apparatus determines an operating parameter of the device and adjusts a power supply operating parameter based on the determined device operating parameter. The apparatus may be a transmitter wirelessly transmitting power to the device or a receiver wirelessly receiving power from the device.

The operating parameter may be frequency, and the apparatus adjusts the power supply frequency to be substantially equal to the device frequency, which may be the device resonant frequency.

The operating parameter may be phase, and the apparatus adjusts the power supply phase to be out of phase with the device. The phase of the power supply may be adjusted to ninety degrees out of phase with the device for maximum power transfer.

### CROSS REFERENCE TO RELATED APPLICATIONS

The present application claims benefit to U.S. provisional application 61/428,143 filed Dec. 29, 2010 entitled Phase Shift Power Transfer, the contents of which is incorporated herein in its entirety.

### BACKGROUND

A wireless energy transfer system may be designed for the maximum transfer of real power from a transmitter to one or more receivers. Energy transfer may be affected by the distance between the receiver and transmitter, the number of receivers attempting to receive energy from a transmitter, and the voltage at the transmitter and receiver, to name just a few limiting factors. Thus, it is desirable to be able to adjust one or more parameters of the receiver or transmitter to adjust the amount of transferred energy.

### FIGURES

FIG. 1A illustrates a representative wireless energy transfer system including a transmitter and a receiver.

FIG. 1B illustrates a representative wireless energy transfer system in pi-model form.

FIG. 2 illustrates a representative wireless energy transfer system in pi-model form with alternating current power sources.

FIG. 3 illustrates a representative wireless energy transfer system with phase control.

FIG. 4 illustrates a representative wireless energy transfer system with multiple receivers.

FIG. 5 illustrates a representative mono-resonant wireless energy transfer system.

FIG. 6 illustrates a phasor relationship between a transmitter and receiver in a wireless energy transfer system.

FIG. 7 illustrates a relationship between load value and power transfer.

### DETAILED DESCRIPTION

In a wireless energy transfer system it is desirable to transfer the maximum amount of real power from a primary coil to a secondary coil with the greatest efficiency possible. Real power transfer, referred to in shortened form as power transfer herein, is affected by multiple design and environmental factors. For example, in one exemplary implementation a secondary coil is included in a portable device such as a computer or a mobile phone or the like. In the exemplary portable device there is a rechargeable battery that is recharged wirelessly with energy received via the secondary coil from a charging device. One design factor affecting power transfer for the exemplary portable device is the voltage limitation of the rechargeable battery. One environment factor affecting power transfer for the exemplary portable device is the distance that the mobile device is from the charging device. The two mentioned factors affecting power transfer for the exemplary portable device are just two of the many design and environmental factors to consider. In other implementations the same or other factors may affect power transfer.

A wireless energy transfer system may be designed to tolerate, compensate for, or otherwise adjust to changing environmental conditions. In some systems, frequency or phase of the transmitter or receiver may be adjusted to modify the maximum power transfer capability or to modify the efficiency of the power transfer. For example, a phase shift may be introduced between the transmitter and receiver to adjust the maximum power transfer capability. In another example, transmitter frequency may be adjusted to match the resonance frequency of the receiver to increase power transfer efficiency.

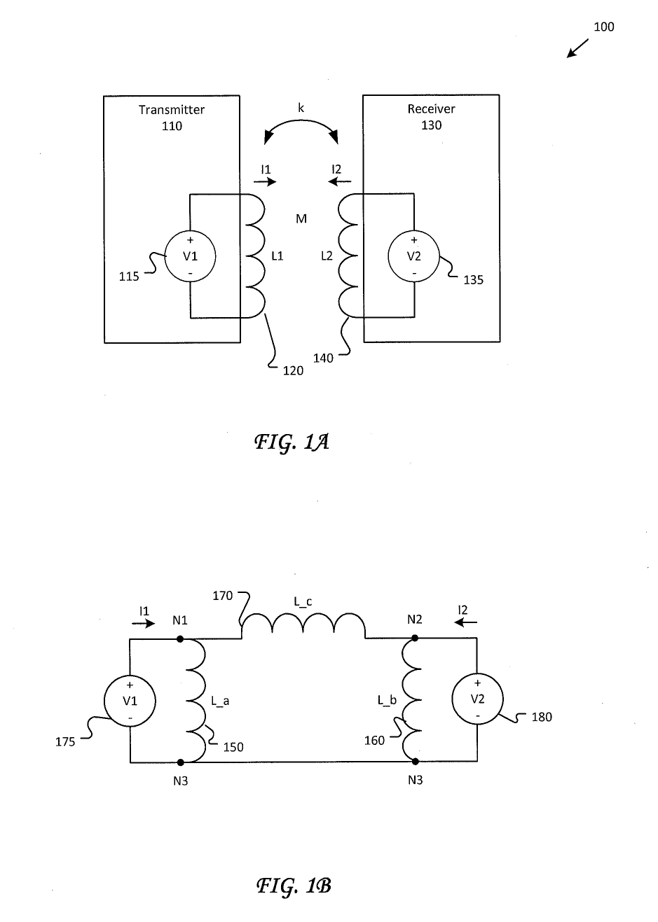

FIG. 1A illustrates a representative wireless energy transfer system 100 including a transmitter 110 with primary coil 120 having inductance L1 and a receiver 130 with secondary coil 140 having inductance L2. A current I1 flows through primary coil 120. A current I2 flows through secondary coil 140. A power source 115 with voltage V1 is applied across coil 120 and a power source 135 with voltage V2 is applied across coil 140. Coils 120 and 140 are coupled with coupling coefficient k. There is a mutual inductance M between primary coil 120 and secondary coil 140.

FIG. 1B illustrates the system 100 of FIG. 1A represented by an equivalent pi (π) model. The n-model includes an inductor 150 having inductance L_a, an inductor 160 having inductance L_b, and an inductor 170 having an inductance L_c. In the π-model, current I1 flows into node N1 and current I2 flows into node N2. Also in the n-model, a power source 175 with voltage V1 located between nodes N1 and N3 and a power source 180 with voltage V2 located between nodes N2 and N3.

The parameters of FIGS. 1A and 1B are related as shown in equations 1-4.

$$\begin{matrix}L\_a = \frac{L 1 * L 2 - {M}^{2}}{L 2 - M} & ( 1 ) \\ L\_b = \frac{L 1 * L 2 - {M}^{2}}{L 1 - M} & ( 2 ) \\ L\_c = \frac{L 1 * L 2 - {M}^{2}}{M} & ( 3 ) \\ M = k \sqrt{L 1 * L 2} & ( 4 )\end{matrix}$$

For small coupling coefficient k, the maximum power Pmax through the circuit is shown in equation 5, where the values for voltages V1 and V2 are in root-mean-square (rms) Volts. In equation 5, the term ω is equal to 2πf where f is the operating frequency of the system 100 power sources, for example power sources 175 and 180.

$$P max = k * \frac{V 1 * V 2}{ω \sqrt{L 1 * L 2}} \qquad ( 5 )$$

From equation 5 it can be seen that maximum power increases with a decrease in frequency or coil inductance and that maximum power increases with an increase in coupling coefficient k or an increase in voltage V1 or V2. Because a higher voltage V1 or V2 may also increase the efficiency of conversion, it may be desirable to operate system 100 with maximum coil voltages.

Ideally the voltages V1 and V2, across the primary and secondary coils respectively, are equal. However, in many implementations it is not practical to have equivalent primary and secondary coil voltages. For example, a portable device acting as a receiver may be limited by size, weight, and cost and the power source thus limited to lower voltages whereas the transmitter power source may be a line voltage of 110V or 220V or the like. Consequently, the primary and secondary coil voltages will not be equal. However, power transfer may still be relatively efficient with unequal primary and secondary coil voltages. In one implementation shown to have sixty percent (60%) efficiency with a maximum power of approximately three Watts (3 W), the primary coil voltage was 100V, secondary coil voltage was 10V, primary coil inductance was 100 μH, secondary coil inductance was 10 μH, and coupling coefficient was k=0.1.

FIG. 1B and equation 5 describe power sources 175 and 180 with voltage amplitude information only, respectively V1 and V2. However, power sources 175 and 180 may be further described using phase information. Analyzing system 100 using both amplitude and phase information provides additional insight into design of the system for maximum power transfer.

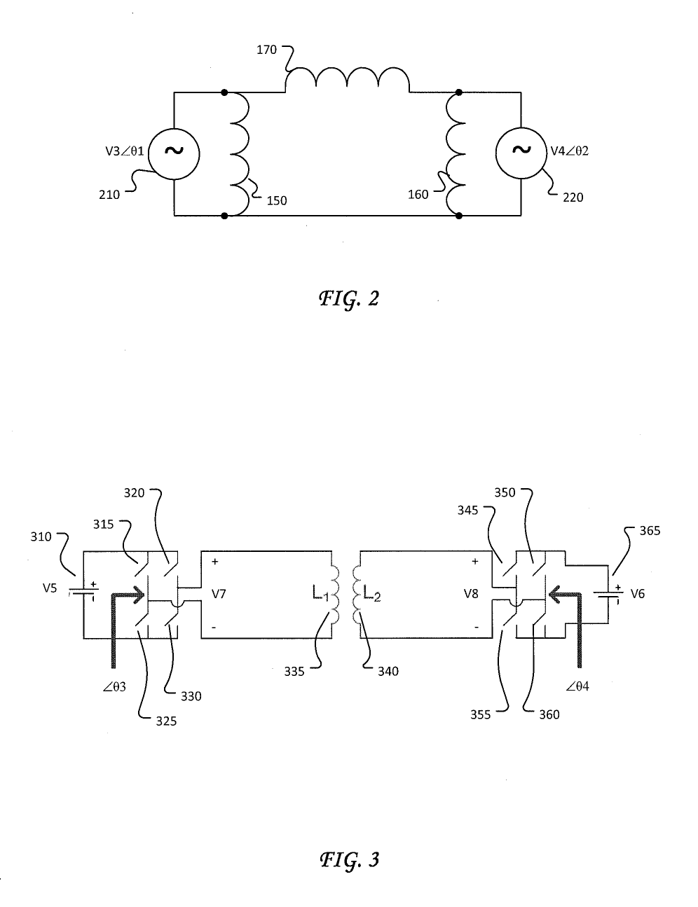

FIG. 2 illustrates the π-model of FIG. 1B with power sources 175 and 180 replaced by alternating current (AC) power sources 210 and 220, respectively, each illustrated as having an amplitude and a phase. Power source 210 provides power at a magnitude V3 and a phase angle θ1. Power source 220 provides power at a magnitude V4 and a phase angle θ2. A phase Φ may be defined as the difference between phase angles θ1 and θ2 such that Φ is the phase angle between the primary and secondary coil voltages at any given time. Equation 5 describing the maximum power through the circuit of FIG. 1A may be modified to describe the maximum power through the circuit of FIG. 2 by including a phase component as shown in equation 6.

$$P max = k * \frac{V 3 * V 4}{ω \sqrt{L 1 * L 2}} * sin ( Φ ) \qquad ( 6 )$$

From equation 6 it can be seen that maximum power transfer between the primary and secondary coils occurs when there is a phase difference of Φ=90 degrees between power sources 210 and 220.

Therefore, maximum power transfer may be achieved by controlling the phase difference Φ to be 90 degrees.

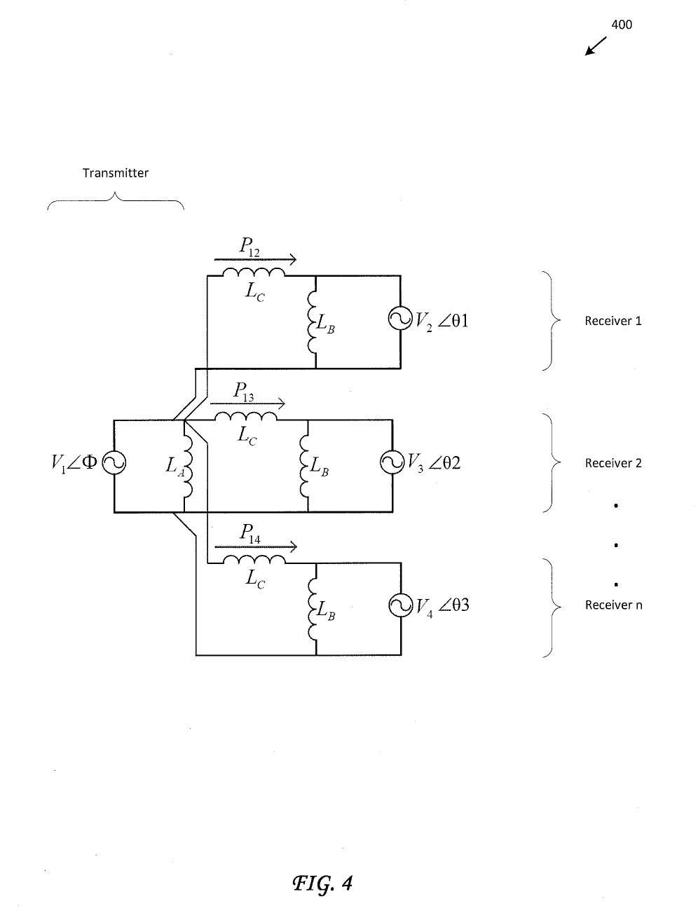

FIG. 3 illustrates one exemplary implementation of a system 100 that allows the phase difference Φ to be controlled. The AC sources 210 and 220 of FIG. 2 are implemented in FIG. 3 using direct current (DC) power sources. DC source 310 having voltage V5 is switched to primary coil 335 through switches 315, 320, 325, and 330 at some frequency with phase angle θ3. The voltage generated by the switching appears to primary coil 335 as an AC source with magnitude V7 and phase angle θ3. DC source 365 having voltage V6 is switched to secondary coil 340 through switches 345, 350, 355, and 360 at some frequency with phase angle θ4. The voltage generated by the switching appears to secondary coil 340 as an AC source with magnitude V8 and phase angle θ4. Thus, the phase difference Φ=θ3-θ4 may be controlled by changing the switching phase angle θ3 of switches 315, 320, 325, and 330 or by changing the switching phase angle θ4 of switches 345, 350, 355, and 360.

Among the advantages that phase angle control may provide is the advantage of fixed frequency operation, and the further advantage that tuning elements are not required. Additionally, the maximized voltage possible from phase angle control provides for power transfer even under low coupling conditions, for example, down to k=0.1.

Maximum power transfer is not always desirable. Therefore, phase difference Φ may be controlled to be less than 90 degrees to meet the needs of the system 100.

Communication between a transmitter and receiver may be implemented to coordinate the switching and thereby achieve a desired phase difference Φ. However, many systems 100 do not include communication of phase information between the transmitter and receiver. Such systems may instead include a phase or frequency loop to automatically synchronize the transmitter and receiver. For example, a phase loop in the receiver may automatically lock on to the phase of the transmitter and the phase information may then be used to set the receiver phase as desired.

In other implementations in which there is no communication of phase information between transmitter and receiver, the phase of either the transmitter or receiver may be swept to determine the phase at which maximum power transfer occurs.

Multiple receivers can be accommodated easily using phase shift power transfer as described above.

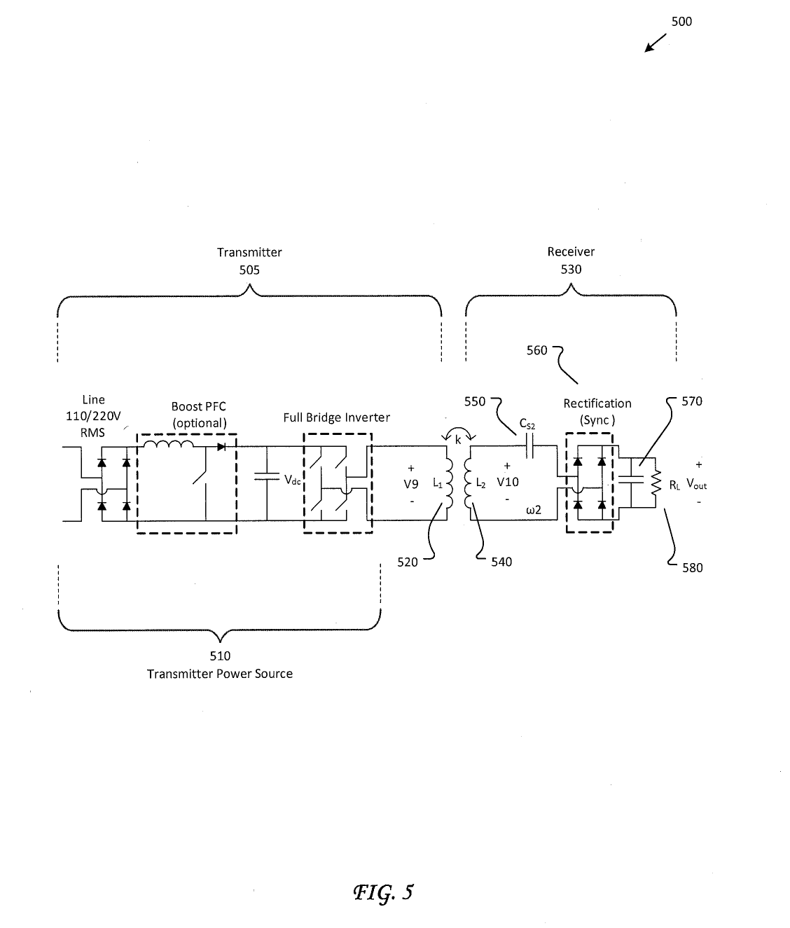

FIG. 4 illustrates an exemplary model of a wireless energy transfer system 400 with a transmitter, indicated as “Transmitter” and multiple receivers, indicated as ‘Receiver 1’, ‘Receiver 2’, and ‘Receiver n’. Three receivers are shown but system 400 may include more or less than three receivers.

There will be negligible power transfer between multiple receivers when there is a phase difference of ninety degrees (90°) between the Transmitter and each Receiver. For example, a set of receivers such as the Receivers illustrated in FIG. 4 have phase θ1=θ2=θ3=0 and Transmitter phase Φ=90° such that maximum power transfer is achieved between the Transmitter and each Receiver. Equation 6 is modified as shown in equation 7, where Pmax12 is the maximum power transfer between Receiver 1 and Receiver 2 and L1 and L2 are the inductances of the coils of Receiver 1 and Receiver 2, respectively.

$$P max 12 = k * \frac{V 2 * V 3}{ω \sqrt{L 1 * L 2}} * sin ( θ 1 - θ 2 ) \qquad ( 7 )$$

Receiver 1 and Receiver 2 are in phase with each other, so that sin(θ1−θ2)=sin(0)=0. Therefore, Pmax12 is substantially equal to zero, and power transfer between Receiver 1 and Receiver 2 is substantially equal to zero. Similarly, power transfer between Receiver 1 and Receiver 3, and power transfer between Receiver 2 and Receiver 3, will be substantially equal to zero.

Therefore, phase shift power transfer not only provides better power transfer from a transmitter to a receiver, but also provides for minimized power transfer between multiple receivers. Additionally, the minimized power transfer between multiple receivers does not require additional computation or communication.

Although the example above included θ1=θ2=θ3=0 for the receivers of FIG. 4, the example was not limiting. Two receivers may each be 90° out of phase with the transmitter but the two receivers may be 180° out of phase with each other. For a 180° phase difference, sin(180°)=0 and maximum power transfer is still zero.

In some implementations, it may not be possible or alternatively may not be desirable for all receivers to be 90° out of phase with the transmitter. However, power transfer between receivers may still be low. For example, a first receiver is 80° out of phase with the transmitter and a second transmitter is 60° out of phase with the transmitter. For power transferred between the transmitter and first receiver, sin(80°)=0.98. For power transferred between the transmitter and second receiver, sin(60°)=0.87. For power transferred between the first receiver and the second receiver, sin(20°)=0.34. Thus, power transfer from transmitter to receivers is relatively high and power transfer between receivers is relatively low even when phase shift between transmitter and receivers is less than 90°.

Further, if the receiver coil voltages are low, as may be the case if the receivers are portable devices, the product of the receiver coil voltages will be low and thus maximum power transfer from one receiver to another will be low relative to the maximum power transfer between transmitter and receiver.

As multiple receivers are added, the representative Transmitter inductance LA in FIG. 4 reduces causing higher circulating currents and hence higher losses in the primary. The number of receivers is therefore limited by transmitter power loss.

Power transfer may be improved through the use of phase angle control as described above and as illustrated by equation 6. Equation 6 also illustrates that power transfer may be improved by increasing one or both of the primary and secondary coil voltages. Coil voltage may be increased through the use of resonance. For example, dual resonance may be employed wherein both the transmitter and receiver are maintained in a resonant mode. Dual mode resonance may boost the voltages at the coils for good power transfer capability even under very low coupling conditions, for example, for k=0.01. However, achieving resonance on both the transmitter side and the receiver side may require tuning elements and communication between the transmitter and receiver regarding phase and frequency information. Such communication may not be available. Therefore, in some implementations resonance is used only on one side of the power transfer, either the transmitter side or the receiver side.

FIG. 5 illustrates an exemplary system 500 using mono-resonance wherein resonance is only on the receiver side. System 500 includes a transmitter 505 and a receiver 530. Transmitter 505 includes power source 510 and primary coil 520 having inductance L1. Receiver 530 includes secondary coil 540 having inductance L2, capacitor 550 having capacitance Cs2, rectification circuit 560, capacitor 570, and load 580 represented by a resistor having resistance RL.

Power source 510 provides one example of an AC source that receives power from a line input, for example at a building power outlet, rectifies the line input to direct current (DC), boosts the rectified line input, stores the energy in a capacitor, and converts the stored energy into an AC signal with controlled frequency and phase for application to primary coil 520.

Secondary coil 540 and capacitor 550 form a resonant circuit with resonance at w2 as shown in equation 8.

$$ω 2 = \frac{1}{\sqrt{L 2 * Cs 2}} \qquad ( 8 )$$

Primary coil 520 is coupled to secondary coil 540 with coupling coefficient k. Power is wirelessly transferred from transmitter 505 to receiver 530 and an output voltage Vout is developed across capacitor 570 and delivered to load 580.

Load 580 is represented in FIG. 5 by a resistor for simplicity and not by way of limitation. Load 580 may actually be many other types of loads, including a battery.

The resonance frequency w0 of system 500 is determined by the inductance of secondary coil 540, the capacitance of capacitor 550, and the coupling coefficient k, as shown in equation 9.

$$ω 0 = \frac{1}{\sqrt{L 2 * Cs 2 * ( 1 - {k}^{2} )}} \qquad ( 9 )$$

For small values of k, equation 7 reduces to equation 10.

$$ω 0 = \frac{1}{\sqrt{L 2 * Cs 2}} = ω 2 \qquad ( 10 )$$

Thus, for small values of k, the resonance frequency of system 500 is substantially equal to the resonance frequency of receiver 530. Based on this result, a frequency sweep may be made in power source 510 to find the system 500 resonance frequency. Power source 510 may then be operated at the resonance frequency for maximum power transfer.

Among the advantages of the mono-resonant system illustrated in FIG. 5 is the advantage of not needing resonance on the transmitter, thereby eliminating the need for resonance tuning elements. A further advantage is that because resonance is only on the receiver side there is no splitting of resonance frequencies from the interaction of two resonant circuits, thus voltages are predictable and, correspondingly, lower voltage circuit elements may be selected.

FIG. 5 is a phasor diagram illustrating a portion of the relationship between the transmitter and receiver of FIG. 5. As seen in the phasor diagram, the system of FIG. 5 automatically adjusts to load transients. In the phasor diagram the phasor E2 represents the primary coil voltage reflected to the secondary coil as an independent source. Equation 11 describes E2.

$$E 2 = k * \sqrt{\frac{L 2}{L 1}} \qquad ( 11 )$$

E2=I2*RL when the receiver is tuned, where I2 is the current through capacitor 550 and RL is the value representing load 580.

E2 is a constant value. Power source voltage V9 and output voltage Vout are also substantially constant values. For higher loading, meaning smaller values of RL, the voltage V10 across the secondary coil must increase to maintain the output voltage. Correspondingly, as seen in FIG. 5, the phase difference D between the primary and secondary coils increases.

Equation 6 is reproduced as equation 12 using the nomenclature of FIG. 5.

$$P max = k * \frac{V 9 * V 10}{ω \sqrt{L 1 * L 2}} * sin ( Φ ) \qquad ( 12 )$$

As phase difference Φ increases, the value of sin(Φ) increases. Thus, as seen in equation 12, because secondary coil voltage V10 and sin(Φ) are increasing, the power transferred increases. Therefore higher load automatically increases the power transfer across the coupled inductor and as such the circuit is stable for load transients.

In addition because of increased phase difference Φ the AC efficiency increases. Thus both power transfer and efficiency increase with higher load. For very high load currents the secondary conduction losses dominate resulting in diminished efficiency.

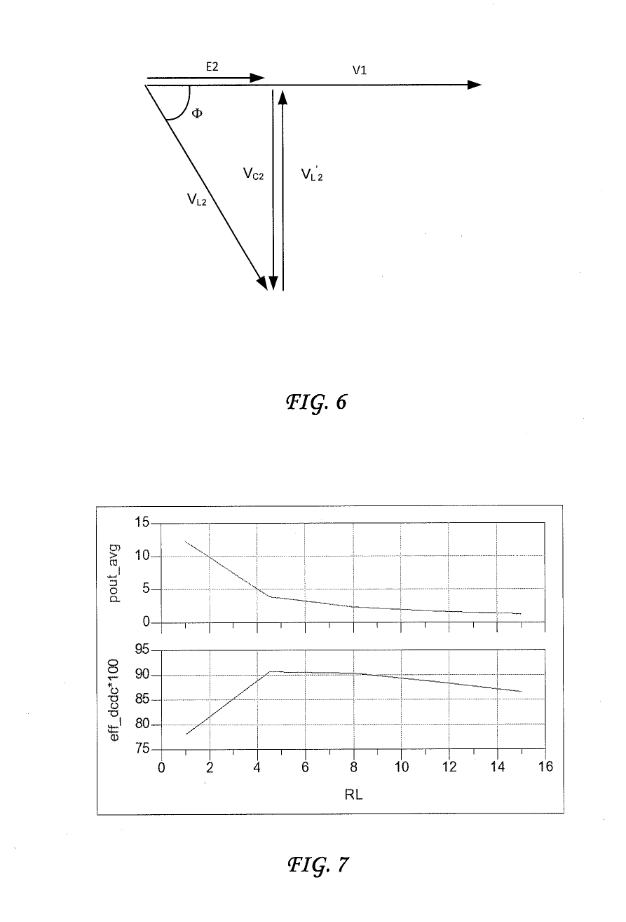

FIG. 6 is a graph that shows the change in power transfer and efficiency versus a change in load. The graph is the product of a simulation on a system substantially similar to the system of FIG. 5, using coupling coefficient k=0.1.

### CONCLUSION

The power transferred in a wireless energy transfer system including a transmitter with a primary coil and a receiver with a secondary coil may be adjusted by adjusting the phase difference between the primary and secondary coils. Maximum power transfer may be achieved when the transmitter and receiver coils are operated ninety degrees out of phase with each other.

The power transferred may be increased by setting the frequency on a first side of the system to the resonant frequency of the other side of the system, thereby increasing the voltage on the first side for increased power transferred.

What is claimed is:

1. An apparatus, comprising:
a coil configured for wireless energy transfer;
an adjustable alternating current power supply electrically connected to the coil;
wherein, when a device is in the vicinity of the apparatus, the apparatus determines an operating parameter of the device, and
based on the device operating parameter, adjusts a power supply operating parameter.

2. The apparatus of claim 1, the operating parameter of the device being determined at least in part by a communication from the device.

3. The apparatus of claim 1, the apparatus being a transmitter and the coil being a primary coil for wireless energy transfer.

4. The apparatus of claim 1, the apparatus being a receiver and the coil being a secondary coil for wireless energy transfer.

5. The apparatus of claim 1, the operating parameter being frequency, the frequency of the power supply being selectively adjusted to be substantially equal to the frequency of the device.

6. The apparatus of claim 5, the frequency being the resonant frequency of the device.

7. The apparatus of claim 5, the frequency of the power supply being swept and power transfer measured to determine the power supply frequency at which a maximum amount of power is transferred between the apparatus and the device.

8. The apparatus of claim 1, the operating parameter being phase, the power supply being selectively adjusted to be out of phase with the device.

9. The apparatus of claim 8, the phase of the power supply being swept and power transfer measured to determine the phase at which a maximum amount of power is transferred between the apparatus and the device.

10. The apparatus of claim 8, the phase of the power supply being adjusted such that the phase of the power supply is ninety degrees out of phase with the device for maximum power transfer capability.

11. The apparatus of claim 10, the device being a wireless energy transmitter and the apparatus being a first receiver, a second receiver being approximately ninety degrees out of phase with the transmitter such that the first receiver and the second receiver are substantially in phase with each other and power transfer between the first receiver and the second receiver is decreased.

12. The apparatus of claim 1, the apparatus being a wireless energy transmitter, the device being one of multiple receivers, the operating parameter being phase, the power supply phase being swept and power transfer measured to determine the phase at which a maximum amount of power is transferred between the apparatus and the multiple receivers and to set the power supply to the determined phase.

13. A method, comprising:
recognizing that a device is in the vicinity of a coil in a wireless energy transfer system;
determining an operating parameter of the device;
adjusting an operating parameter of a power supply in the wireless energy transfer system based on the determined device operating parameter.

14. The method of claim 13, further comprising:
receiving a communication from the device; and
determining the operating parameter at least in part from the communication.

15. The method of claim 13, the device being a transmitter and the coil being a secondary coil for wireless energy transfer.

16. The method of claim 13, the device being a receiver and the coil being a primary coil for wireless energy transfer.

17. The method of claim 13, the operating parameter being frequency, further comprising:
adjusting the frequency of the power supply to be substantially equal to the frequency of the device.

18. The method of claim 17, the frequency being the resonant frequency of the device.

19. The method of claim 17, further comprising:
sweeping the frequency of the power supply; and
determining the frequency at which a maximum amount of power is transferred between the coil and the device.

20. The method of claim 13, the operating parameter being phase, further comprising:
adjusting power supply phase to be out of phase with the received signal.

21. The method of claim 20, further comprising:
adjusting the phase of the power supply such that the phase of the power supply is ninety degrees out of phase with the device for maximum power transfer capability.

22. The method of claim 20, further comprising:
determining the operating parameter of the device by sweeping the phase of the power supply and identifying a phase at which a maximum amount of power is transferred between the coil and the device.

23. A system, comprising:
At least one transmitter including
a primary coil; and
a first power supply electrically connected to the primary coil; and
at least one receiver including
a secondary coil; and
a second power supply electrically connected to the secondary coil;
wherein the at least one transmitter and the at least one receiver are configured for wireless energy transfer between the primary coil and the secondary coil; and
wherein phase of one of the first power supply or second power supply is adjusted based on a determination of phase of the other of the first power supply or second power supply.
